(19) United States
(12) Patent Application Publication
(10) Pub. No.: US 2015/0348430 A1
(43) Pub. Date: Dec. 3, 2015

(54) Method for Addressing Language-Based Learning Disabilities on an Electronic Communication Device

(71) Applicant: Laura Marie Kasbar, Spokane, WA (US)

(72) Inventor: Laura Marie Kasbar, Spokane, WA (US)

(21) Appl. No.: 14/726,451

(22) Filed: May 29, 2015

Related U.S. Application Data
(60) Provisional application No. 62/004,690, filed on May 29, 2014.

(51) Int. Cl. G09B 5/06; G09B 19/00; G09B 7/00

(52) U.S. Cl. CPC G09B 5/06; G09B 7/00; G09B 19/00

(57) ABSTRACT

An application which introduces a teaching method for individuals with language-based learning difficulties includes a computer device and a plurality of lesson plans. Each of the plurality of lesson plans includes audio teaching data, visual teaching data, and a presentation schedule. The audio teaching data and the visual teaching data are presented to a user profile according to the presentation schedule such that the user can learn the concepts at a faster rate when compared to traditional teaching methods. Moreover, the plurality of lesson plans addresses issues related to pronouns, verbs, and tense in grammar. When presenting the audio teaching data and the visual teaching data is complete, the application prompts the user profile execute a testing process. Based on the testing process, the application creates a progress report which represents the proficiency of the user.

The current application claims a priority to the U.S. Provisional Patent application Ser. No. 62/004,690 filed on May 29, 2015.

### FIELD OF THE INVENTION

The present invention relates generally to the field of language learning. More specifically, the present invention introduces an application that can be used to enhance the learning skills of an individual with language-based learning disabilities.

### BACKGROUND OF THE INVENTION

Language-based learning disabilities are issues related to age-appropriate reading, spelling, and/or writing. These disabilities can occur in any individual regardless of their intelligence level. Even though specific teaching methods exist for individuals with learning disabilities, the success rate of these methods is questionable.

Dyslexia has been used to refer to learning disabilities related to reading. An individual with dyslexia as part of a larger language-based learning disability will have difficulties in expressing ideas clearly, learning new vocabulary, understanding questions and following directions, reading and comprehending material, and many other related difficulties. Currently, customized programs are used to treat individuals with dyslexia.

Language-based learning disabilities have a direct impact on an individual's confidence. The stress from these language-based learning difficulties can lead to the individual giving up on academic activities. Therefore, it is essential to find a method that can address language-based learning disabilities in a timely manner. In particular, a method that identifies the level of language-based learning disability and addresses the issue appropriately is required.

A majority of these programs that address language-based learning disabilities are based around the school activities of a student. Therefore, the individual focus given to pronouns, verbs, and tense in grammar, which are essential in language learning, is fairly limited. In particular, most teaching methods either focus on teaching only the verb such that the verb is isolated from the tense and the pronoun. In another instance, the verb and the tense is taught while ignoring the pronoun. Since the pronoun, the verb, and the tense are taught independently, the time a student needs to understand the combination of the pronoun, the verb, and the tense is considerably long.

The objective of the present invention is to address the aforementioned issues. In order to do so, the present invention introduces an application that allows the individual with language-based learning difficulties to learn the language at a faster rate. The user is presented with audio-visual data related to the use of pronouns, verbs, and tense that expresses time reference in grammar. The audio-visual data combines the past tense, present tense, and the future tense of a verb with specific pronouns such that the user is presented the data in one viewing. As a result, the audio-visual data helps the individual utilizing the present invention comprehend the information at a faster rate.

### BRIEF DESCRIPTION OF THE DRAWINGS

FIG. 1 is a flowchart illustrating the basic overall process of the present invention.

FIG. 2 is a flowchart illustrating the basic overall process of teaching the pronoun and the gerund.

FIG. 3 is a flowchart illustrating the basic overall process of using a visual representation of the human mouth speaking the pronoun and the gerund.

FIG. 4 is a flowchart illustrating the basic overall process teaching tense in grammar.

FIG. 5 is a flowchart illustrating the basic overall process of teaching the future tense of a verb.

FIG. 6 is a flowchart illustrating the basic overall process of teaching the gerund form of a verb.

FIG. 7 is a flowchart illustrating the basic overall process of teaching the past tense of a verb.

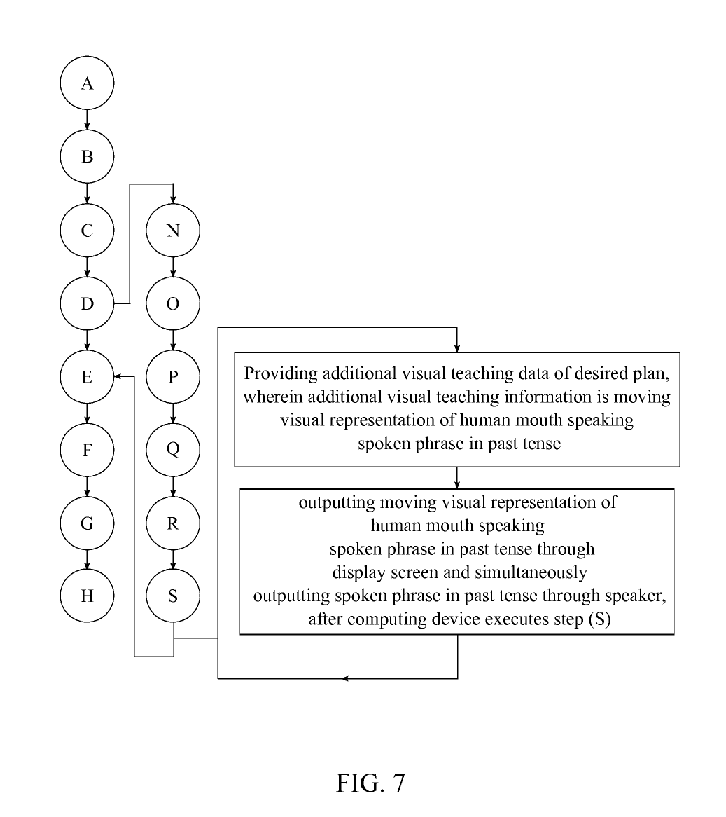

FIG. 8 is a flowchart illustrating the basic overall process of teaching pronoun instruction by comparison.

FIG. 9 is another flowchart illustrating the basic overall process of teaching pronoun instruction by comparison.

FIG. 10 is a flowchart illustrating the basic overall process of prompting the user to generate a socially appropriate response.

FIG. 11 is another flowchart illustrating the basic overall process of prompting the user to generate a socially appropriate response.

FIG. 12 is a flowchart illustrating the basic overall process of teaching the phonemic awareness.

FIG. 13 is another flowchart illustrating the basic overall process of teaching the phonemic awareness.

FIG. 14 is a flowchart illustrating the basic overall process of a testing process.

FIG. 15 is a flowchart illustrating the basic overall process of another testing process.

### DETAIL DESCRIPTIONS OF THE INVENTION

All illustrations of the drawings are for the purpose of describing selected versions of the present invention and are not intended to limit the scope of the present invention.

The present invention introduces a teaching method for individuals with language-based learning difficulties. By utilizing the teaching method of the present invention, which includes visual teaching data and audio teaching data, it is guaranteed that an individual with language-based learning difficulties can learn the language at a faster pace. In order to do so, the audio teaching data and the visual teaching data is presented in a specific manner through a software application on a non-transitory computer readable medium.

The present invention is made accessible to the individual with language-based learning difficulties through a computing device provided by the present invention. In order to fulfill the requirements of the present invention, the computing device includes a display screen, a speaker, and a user input device. The present invention provides a plurality of lesson plans through the computing device. Each of the plurality of lesson plans includes audio teaching data, visual teaching data, and a presentation schedule. The audio teaching data and the visual teaching data correspond to predetermined sections in language, which are known to be problematic for individuals with language-based learning difficulties. The audio teaching data and the visual teaching data are organized according to the presentation schedule which is effectively designed to cater to the individuals with language-based learning difficulties.

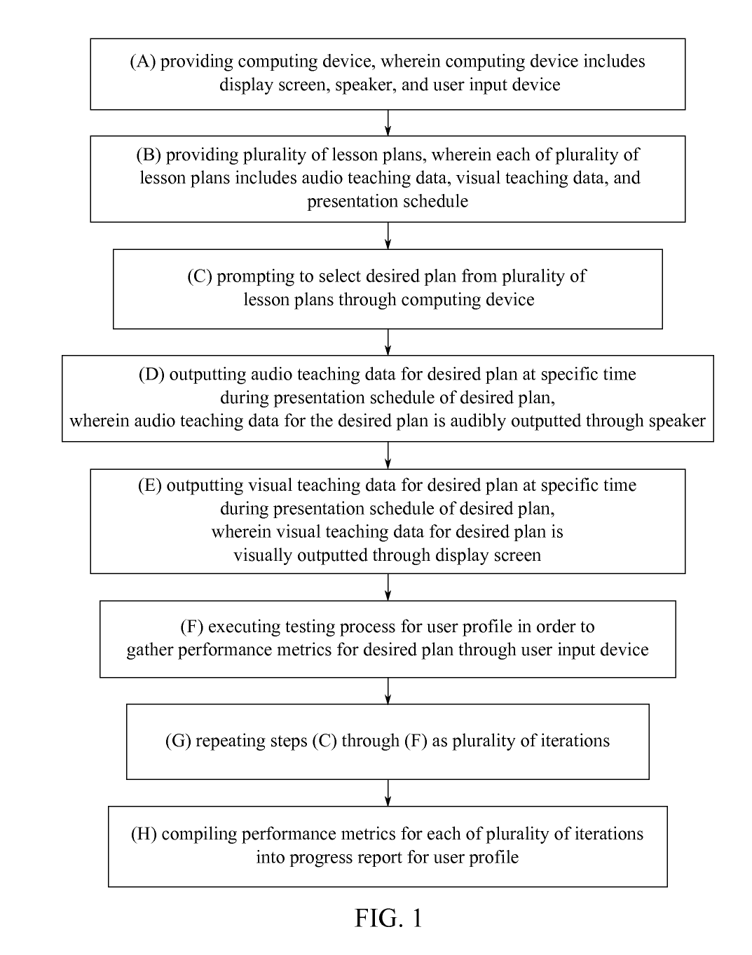

FIG. 1 is a flowchart illustrating the basic overall process of the present invention. In order to initiate the teaching method, the present invention prompts a user profile to select a desired plan from the plurality of lesson plans through the computing device. The desired plan can differ according to the proficiency level of the user and also the specific necessities associated with the user. When the user profile selects the desired plan, the present invention outputs the audio teaching data for the desired plan at a specific time during the presentation schedule of the desired plan. Moreover, the audio teaching data for the desired plan is audibly outputted through the speaker. The audio teaching data is helpful in demonstrating pronunciation. When the audio teaching data is audibly played, the present invention subsequently outputs the visual teaching data. More specifically, the visual teaching data for the desired plan, at a specific time during the presentation schedule of the desired plan, is visually outputted through the display screen. The visual teaching data helps the user better understand the concept which was previously presented through the audio teaching data. Upon presenting the audio teaching data and the visual teaching data the present invention executes a testing process for the user profile in order to gather performance metrics for the desired plan through the user input device. The steps of selecting the desired plan, outputting the audio teaching data, outputting the visual teaching data, and executing the testing process are then repeated as a plurality of iterations. When the user profile completes the plurality of lesson plans, the performance metrics for each of the plurality of iterations are compiled into a progress report for the user profile. The progress of the individual experiencing language-based learning difficulties can be determined from the progress report.

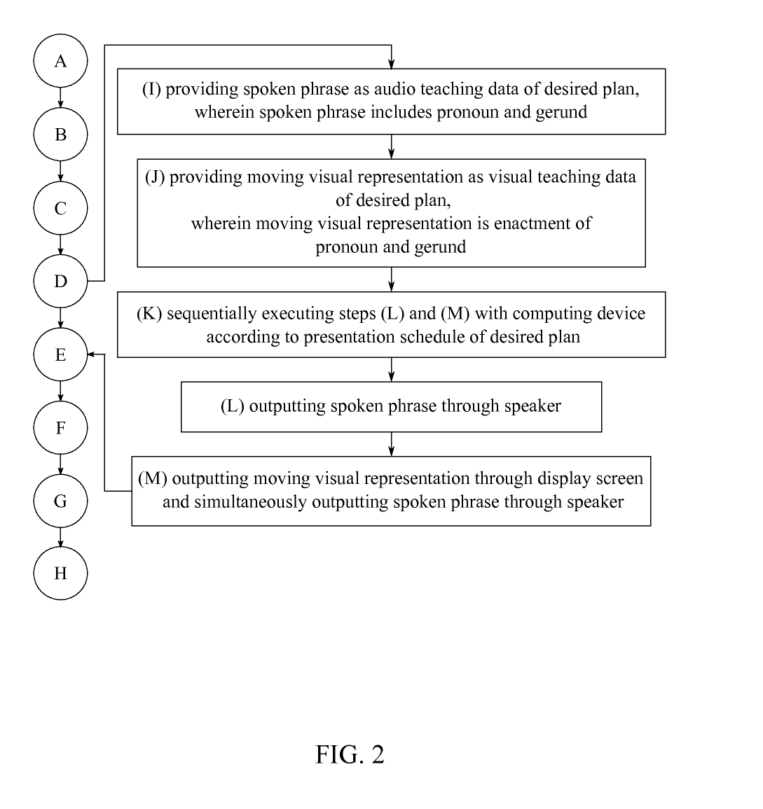

In most teaching methods utilized to teach individuals with language-based learning difficulties, the verb and the pronoun are taught separately. As a result, individuals with language-based learning difficulties require additional effort in understanding both the pronoun and the verb together. In order to address the issue, the present invention provides a spoken phrase as the audio teaching data of the desired plan, wherein the spoken phrase includes a pronoun and a gerund. As seen in FIG. 2, the present invention also provides a moving visual representation as the visual teaching data. The moving visual representation is an enactment of the pronoun and the gerund of the spoken phrase. The moving visual representation helps the user establish a connection between the audio teaching data and the visual teaching data. In order to do so, the present invention sequentially outputs the audio teaching data and the video teaching data according to the presentation schedule of the desired plan. More specifically, the speaker outputs the spoken phrase allowing the user to get an understanding of the pronunciation which is essential in recognizing the pronoun and the gerund. The spoken phrase can be played through the speaker while displaying a still image of a girl on the display screen. Next, the display screen outputs the moving visual representation and simultaneously outputs the spoken phrase through the speaker. As an example, if the spoken phrase is “she is dancing”, the spoken phrase is initially played through the speaker. In the following phase, the display screen shows a girl dancing, while simultaneously outputting the spoken phrase through the speaker. In another example, if the spoken phrase is “they are dancing”, the display screen shows a group of people dancing while outputting the spoken phrase through the speaker.

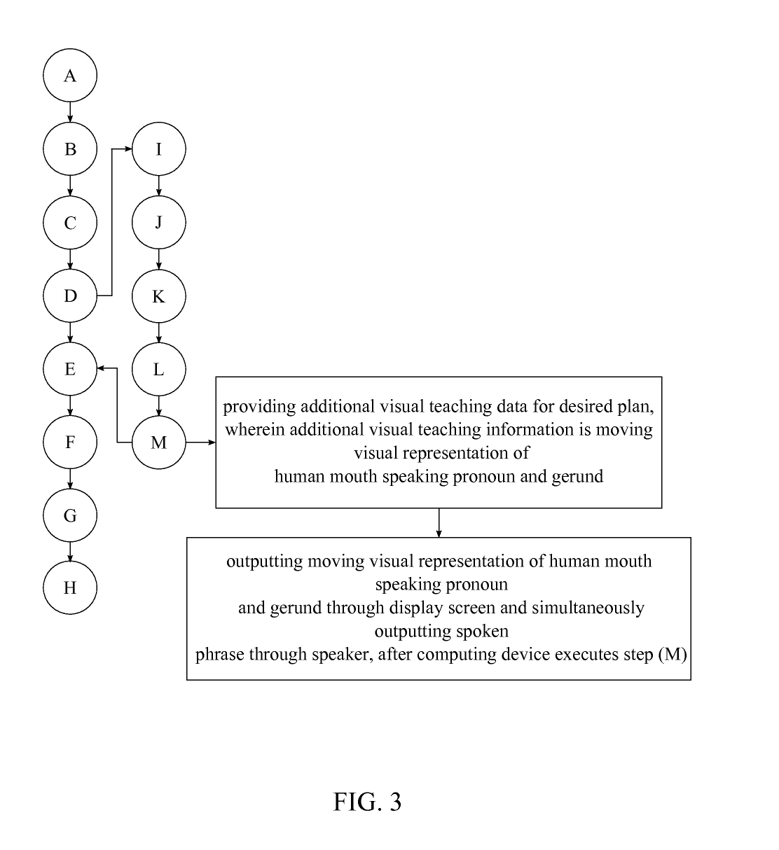

Research has shown that seeing the vocal expression of the spoken phrase helps an individual better understand the spoken phrase. In order to implement articulation into the present invention, the present invention provides additional visual teaching data for the desired plan as illustrated in FIG. 3. More specifically, the additional visual teaching information is a moving representation of a human mouth speaking the pronoun and the gerund of the spoken phrase. Following the phase in which the present invention displays the girl dancing along with the spoken phrase, the present invention subsequently outputs the moving visual representation of the mouth. Similarly, the spoken phrase is also simultaneously played through the speaker. Referring to the previous example, the moving visual representation of the human mouth will display the spoken phrase “she is dancing”. If the spoken phrase was “they are dancing”, the moving visual representation of the human mouth will change accordingly to depict “they are dancing”.

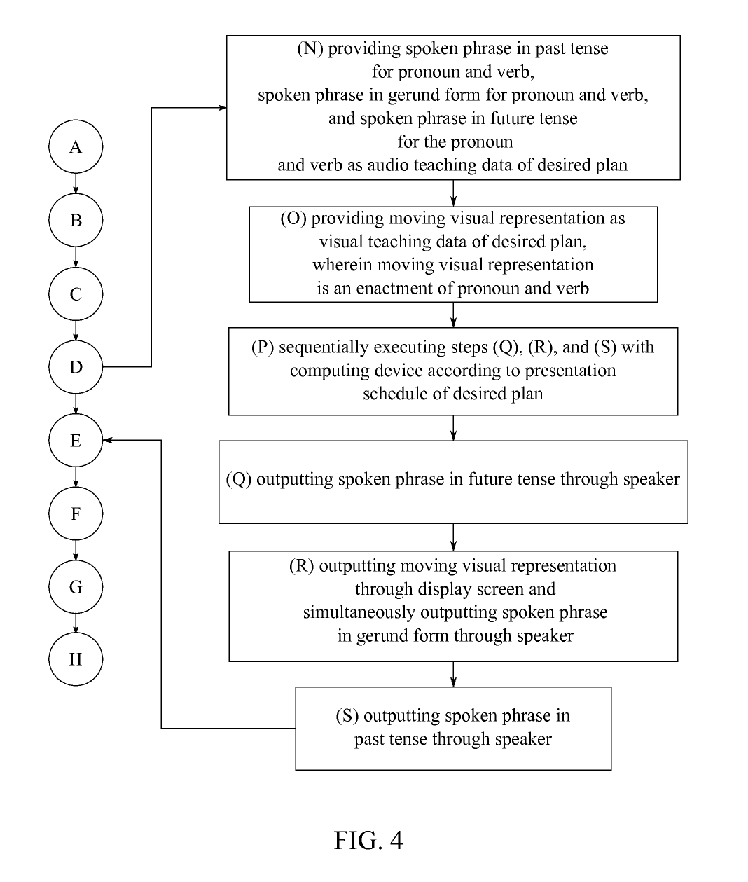

Upon completing the desired plan for the pronoun and the gerund, the present invention focuses on adding tense to the spoken phrase as seen in FIG. 4. In order to do so, the present invention provides a spoken phrase in past tense for a pronoun and a verb, a spoken phrase in gerund form for the pronoun and the verb, and a spoken phrase in future tense for the pronoun and the verb as the audio teaching data of the desired plan. In order to further illustrate the spoken phrase, the present invention also provides a moving visual representation as the visual teaching data of the desired plan, wherein the moving visual representation is an enactment of the pronoun and the verb. When the user profile selects the desired plan dedicated for teaching tense in grammar, along with the pronoun and the verb, the present invention sequentially executes the following steps. As an initial step, the present invention outputs the spoken phrase in future tense through the speaker. As an example, the spoken phrase in future tense can be, but is not limited to, “I am going to blink”. In correspondence, the present invention outputs the moving visual representation through the display screen. Referring to the previous example, a person blinking is shown on the display screen. While the display screen outputs the moving visual representation, the present invention simultaneously outputs the gerund form through the speaker. In this example, “I am blinking” is audibly played through the speaker. When the action in the moving visual representation completely stops, the present invention outputs the spoken phrase through the speaker. In this example, “I blinked” is audibly played through the speaker. Incorporating the spoken phrase in future tense, present tense, and past tense along with the moving visual representation helps the individual with language-based learning difficulties to better understand the tense in grammar along with verb variations.

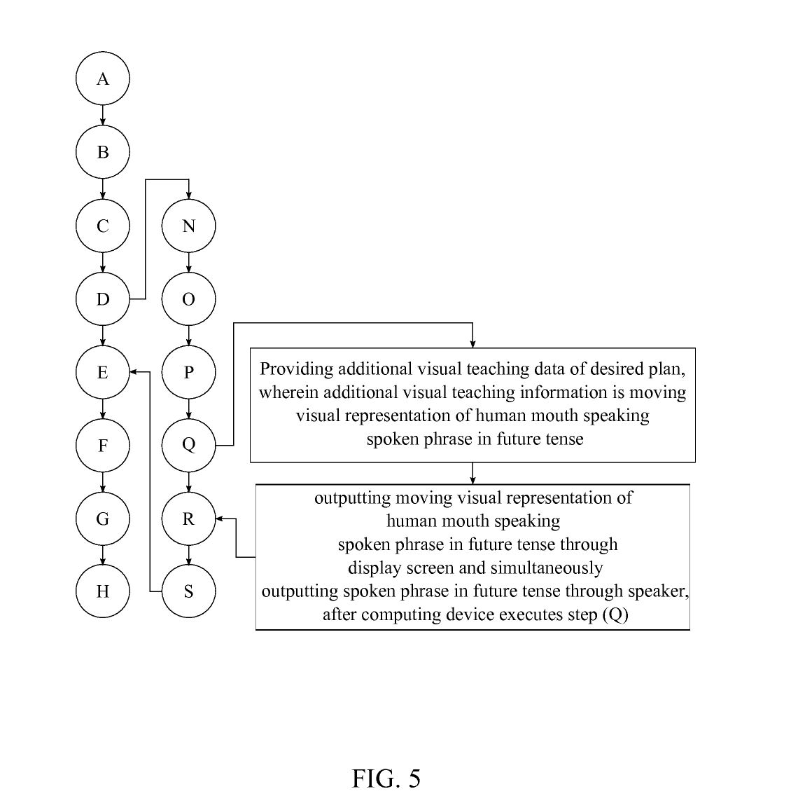

As discussed earlier, articulation is essential in understanding a concept in language. To further illustrate the concept of tense, the present invention provides additional visual teaching data of the desired plan as seen in FIG. 5. The additional visual teaching information is a moving representation of a human mouth speaking the spoken phrase in future tense. Referring to the previous example, the moving representation of the spoken phrase in future tense is, “I am going to blink”. The present invention outputs the moving visual representation of the human mouth speaking the spoken phrase in future tense through the display screen and simultaneously outputs the spoken phrase through the speaker. Therefore, the user can hear the pronunciation and also see the articulation of “I am going to blink”.

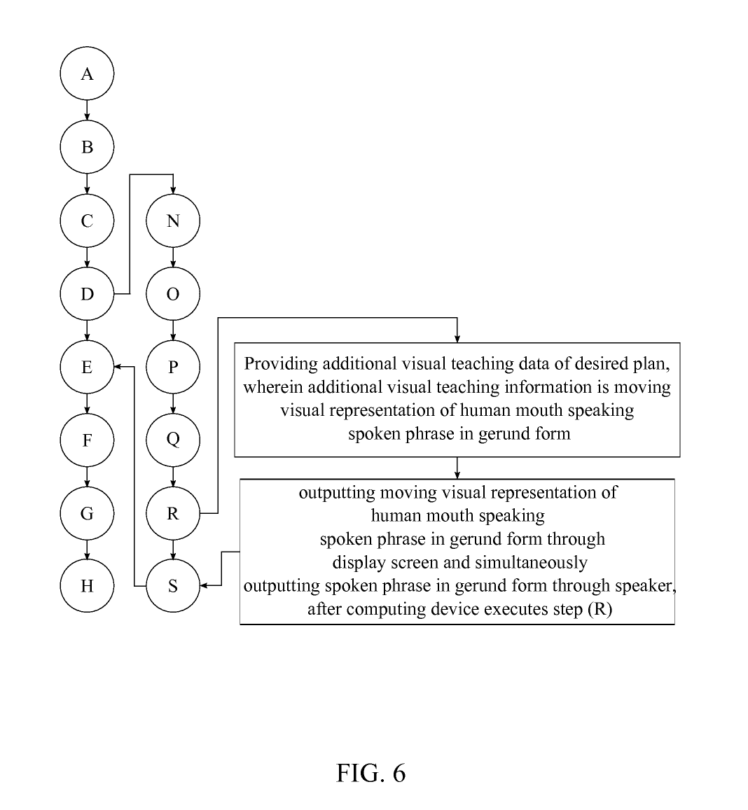

For the user with language-based learning difficulties to better understand the present tense, the present invention provides additional visual data of the desired plan, wherein the additional visual teaching information is a moving representation of a human mouth speaking the spoken phrase in gerund form. When considering the previous example, the spoken phrase in gerund form is “I am blinking”. The present invention outputs the moving visual representation of the human mouth speaking the spoken phrase in gerund form through the display screen and simultaneously outputs the spoken phrase through the speaker. As illustrated in FIG. 6, the user can hear the pronunciation and also see the articulation of “I am blinking”.

Similar to the future tense and the present tense, the present invention also provides additional visual teaching data of the desired plan for the past tense. More specifically, the additional visual teaching information is a moving visual representation of a human mouth speaking the spoken phrase in the past tense. According to the previous example, “I blinked” is provided as the spoken phrase in the past tense. The moving visual representation of the human mouth speaking the spoken phrase in past test is displayed through the display screen and the spoken phrase is simultaneously played through the speaker. Therefore, the user hears the pronunciation of “I blinked” and also simultaneously sees the articulation of “I blinked”.

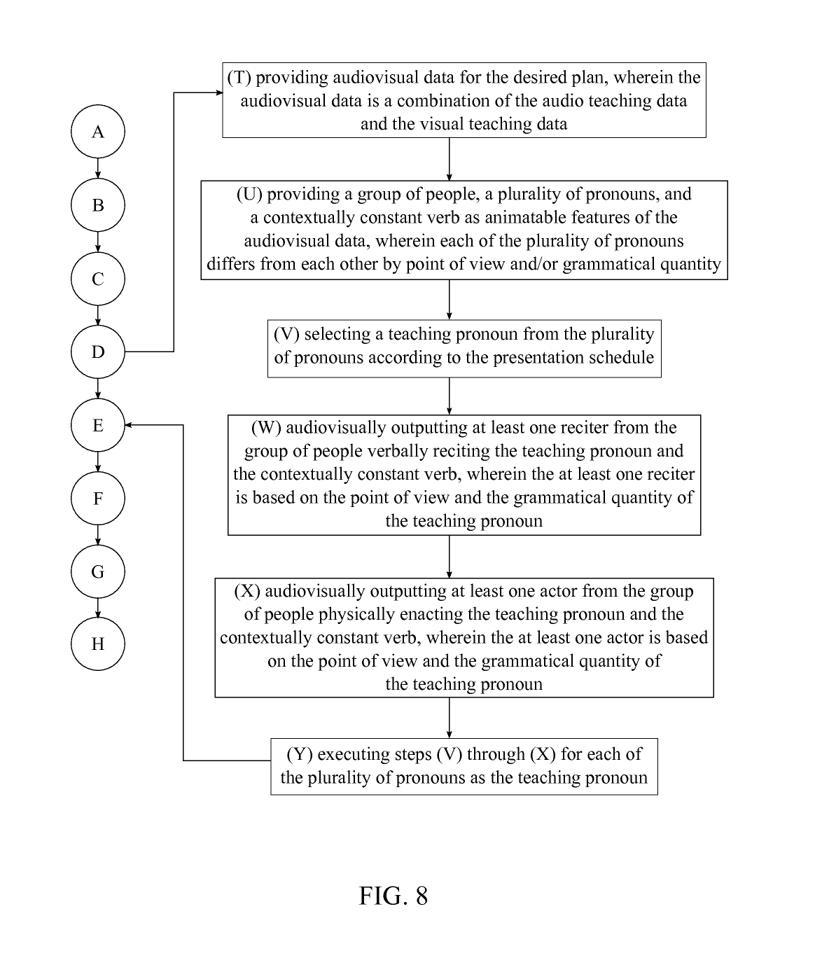

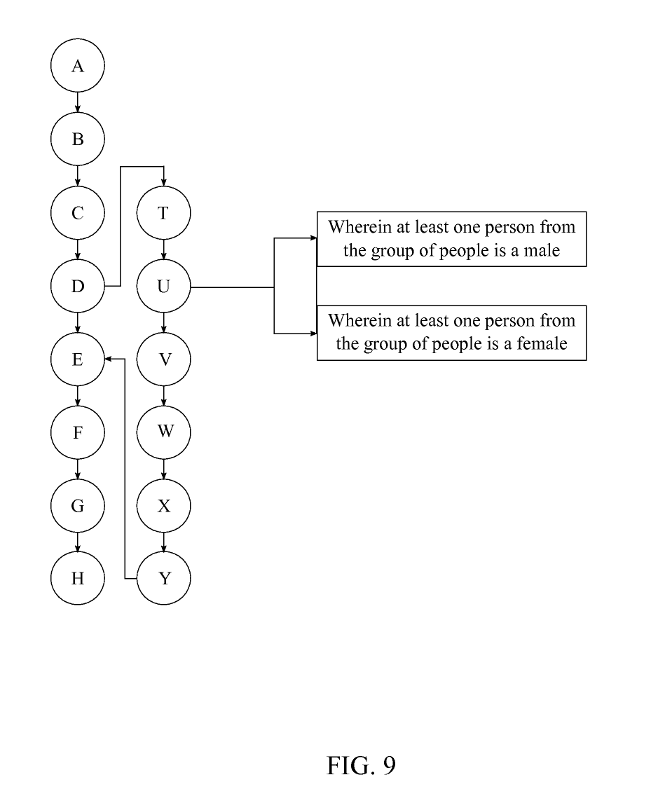

Certain individuals understand independent concepts better than a combination of concepts. This is especially true in individuals with language-based learning difficulties. In order to address the issue, the present invention provides audiovisual data for the desired plan. In particular, the audiovisual data is a combination of the audio teaching data and the visual teaching data. As illustrated in FIG. 8, the present invention also provides a group of people, a plurality of pronouns, and a contextually constant verb as animatable features of the audiovisual data. The plurality of pronouns are utilized to describe the group of people. As shown in FIG. 9, at least one person from the group of people is male. As further illustrated in FIG. 9, at least one person from the group of people is female such that different pronouns can be effectively described. Since different individuals are present in the group of people, each of the plurality of pronouns differs from each other by point of view and/or grammatical quantity. In order to teach the subject matter in relation to the group of people, the present invention selects a teaching pronoun from the plurality of pronouns according to the presentation schedule. As an example, if the contextually constant verb is “clap”, the teaching pronoun can be, but is not limited to, he, she, and they. When the teaching pronoun is selected, the present invention audiovisually outputs at least one reciter from the group of people. The at least one reciter verbally recites the teaching pronoun and the contextually constant verb such that the at least one reciter is based on the point of view and the grammatical quantity of the teaching pronoun. As an example, if the at least one reciter is describing a single person, the present invention outputs the phrase “he is clapping” or “she is clapping”. In contrast, if multiple people are described, the present invention outputs the phrase “they are clapping”. In correspondence, the present invention outputs at least one actor from the group of people physically enacting the teaching pronoun and the contextually constant verb. More specifically, the at least one actor is based on the point of view and the grammatical quantity of the teaching pronoun. If the at least one reciter outputs “she is clapping”, a female from the group of people physically enacts the teaching pronoun. On the other hand, if the at least one reciter outputs “they are clapping”, several members of the group of people physically enact the teaching pronoun. If the at least one reciter is an actor, the at least one reciter outputs “we are clapping”. In order to cover all possibilities, the present invention selects each of the plurality of pronouns as the teaching pronoun. As previously completed, the speaker is utilized to audibly output the audio teaching data. Furthermore, the display screen is utilized to output the visual teaching data.

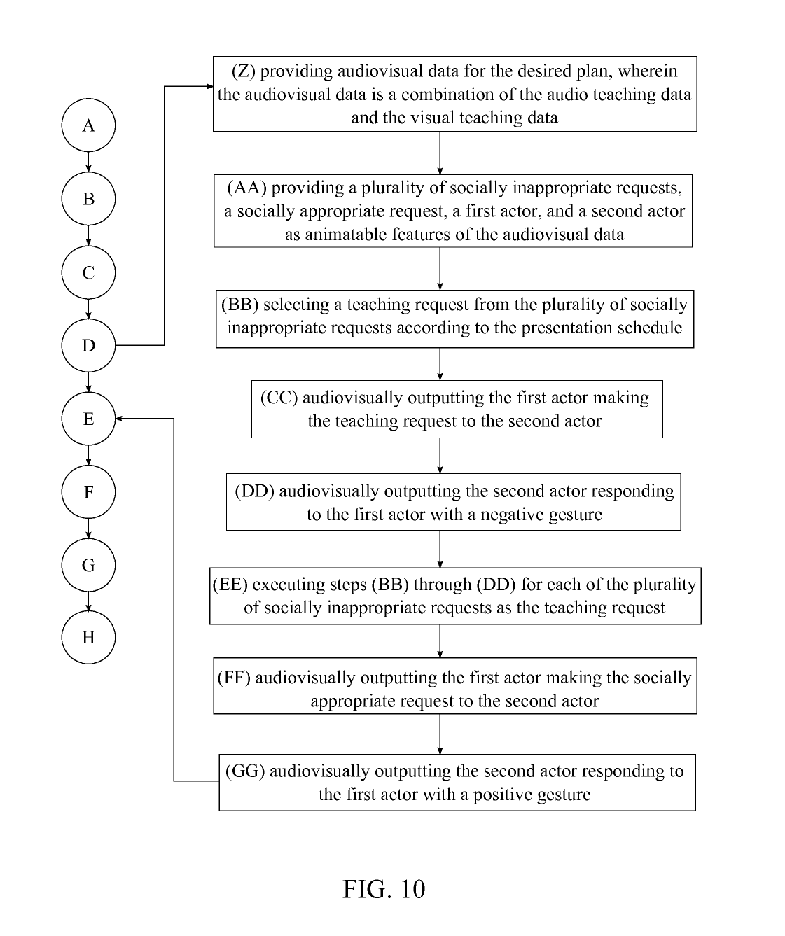

Individuals with language-based learning difficulties have setbacks in constructing an appropriate response for daily situations. In order to effectively train the individuals with language-based learning difficulties, the present invention provides audiovisual data for the desired plan. More specifically, the audiovisual data is a combination of the audio teaching data and the visual teaching data. As illustrated in FIG. 10, the present invention provides a plurality of socially inappropriate requests, a socially appropriate request, a first actor, and a second actor as animatable features of the audiovisual data. The process of teaching the user of the socially acceptable answers is initiated when the user profile selects a teaching request from the plurality of socially inappropriate requests according to the presentation schedule. When the teaching request is selected, the present invention audiovisually outputs the first actor making the teaching request to the second actor. Let us consider an example, wherein the first actor wants to request a marker from the second actor. If the request by the first actor is inappropriate, the present invention audiovisually outputs the second actor responding to the first actor with a negative gesture. The first actor makes a plurality of requests to the second actor. More specifically, each of the plurality of socially inappropriate requests are considered to be a teaching request. As a result, the user get a thorough understanding of the socially inappropriate requests. Upon completing the plurality of inappropriate requests, the present invention audiovisually outputs the first actor making the socially appropriate request to the second actor. When the appropriate request is made, the second actor responds to the first actor with a positive gesture. As a result, the user gets an understanding of the appropriate request. Considering the example in which the first actor requests the marker, the second actor responds with a positive gesture if the first actor requests for the marker by saying “can I color please”.

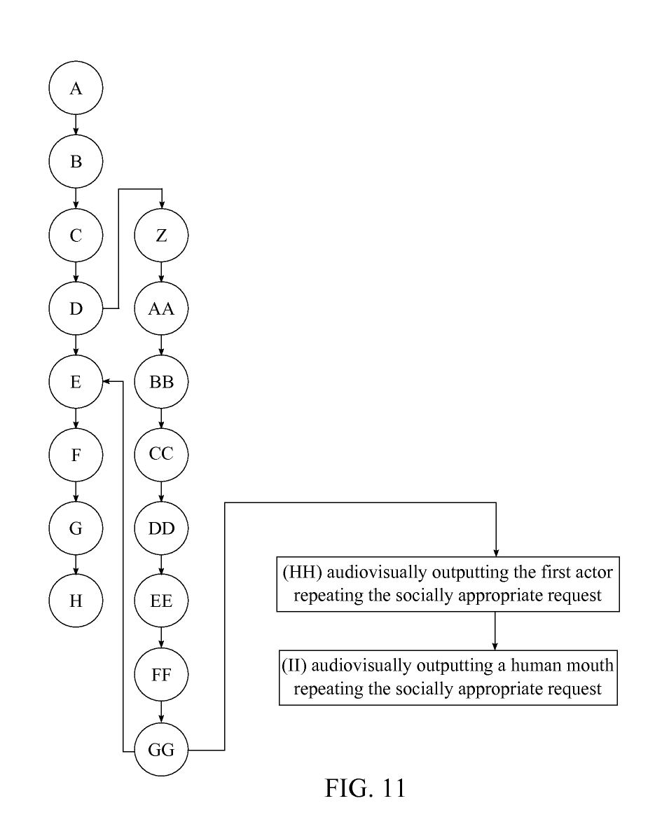

As mentioned previously, articulation is beneficial for the user to better understand a concept. Therefore, the present invention audiovisually outputs the first actor repeating the socially appropriate request such that the user gets a better understanding of the pronunciation of the appropriate request. As seen in FIG. 11, the present invention audiovisually outputs a human mouth repeating the socially appropriate request such that the user is able to see the articulation of the appropriate request. As executed in previous instances, a combination of the speaker and the display screen are utilized to convey the teaching method to the user profile.

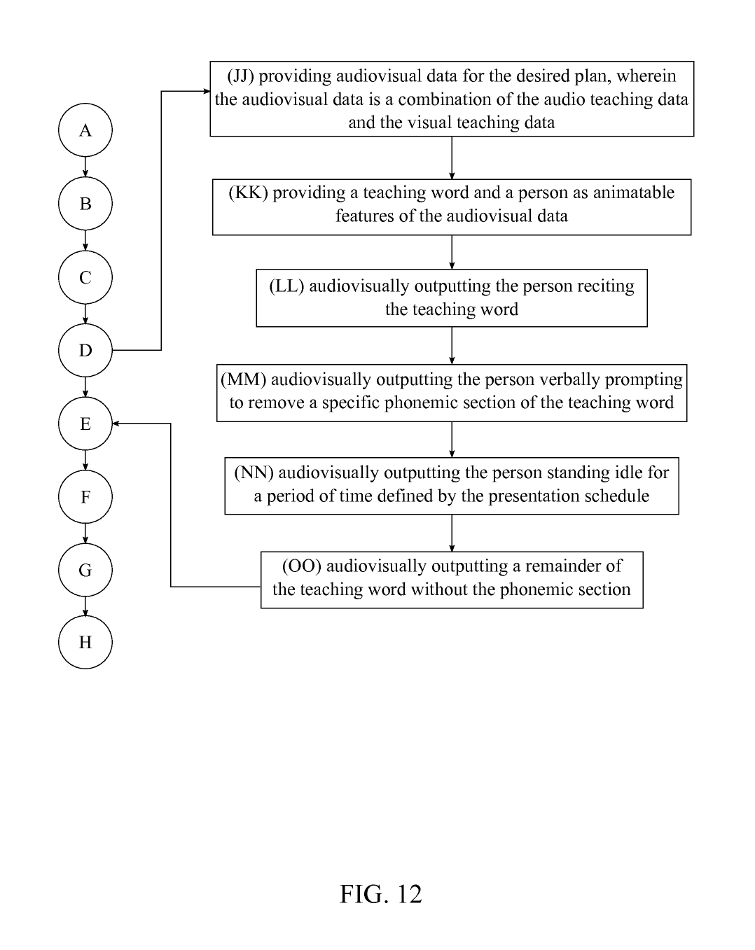

Certain individuals, especially individuals with dyslexia have difficulties recognizing words that are a combination multiple words. The present invention addresses the issue by providing a teaching words and a person as animatable feature of the audiovisual data. The process of teaching is initiated when the present invention audiovisually outputs the person reciting the teaching word. As an example the word “artful” is recited. Next, the present invention audiovisually outputs the person verbally prompting to remove a specific phonemic section of the teaching word. For instance, the user is prompted to recite the word that is created without “ful” from “artful”. In order to respond to the question, the user profile is given a designated time period. In order to do so, the present invention audiovisually outputs the person standing idle for a period of time defined by the presentation schedule. As shown in FIG. 12, when the period of time expires, the present invention audiovisually outputs a remainder of the teaching word without the phonemic section. Considering the previous example, the word “art” is audiovisually played as the remainder of the teaching word. As executed in previous steps, a combination of the speaker and the display screen are utilized to convey the desired plan of the plurality of lesson plans to the user profile.

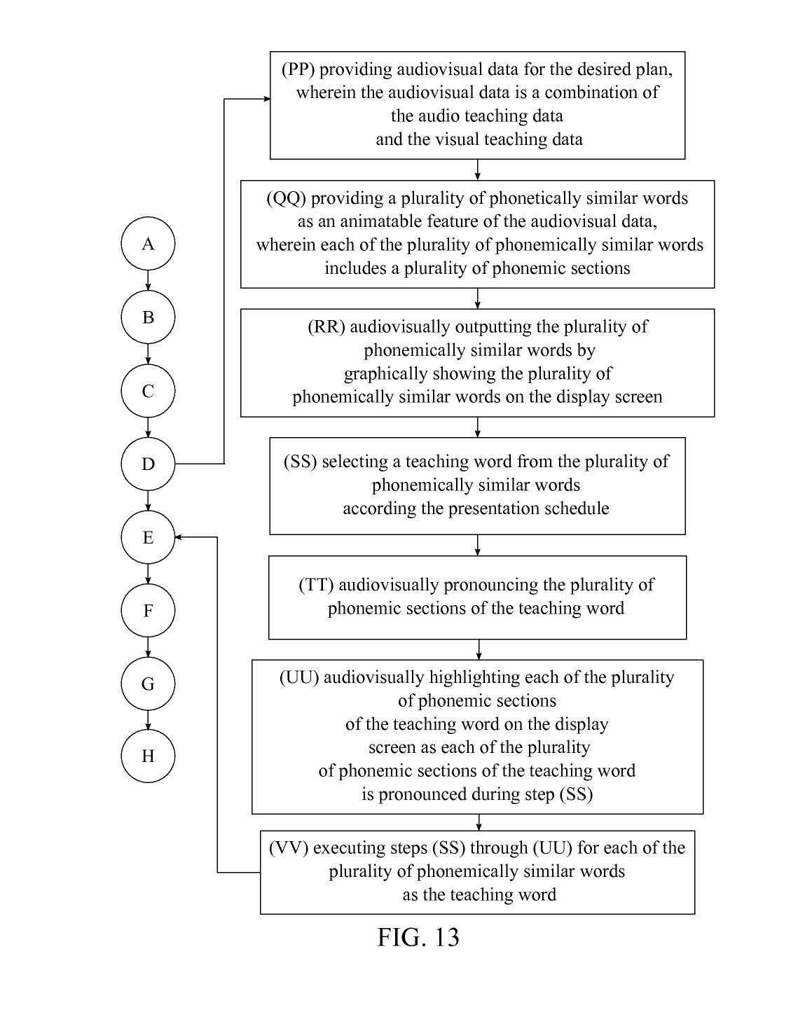

Homonyms are another area which is problematic for individuals with language-based learning difficulties. The similar pronunciation often creates complications since the user is unable to separate one word from the other. In order to address the issue, the present invention provides a plurality of phonetically similar words as an animatable feature of the audiovisual data, wherein each of the plurality of phonemically similar words includes a plurality of phonemic sections. As illustrated in FIG. 13, when the desired plan is initiated, the present invention audiovisually outputs the plurality of phonemically similar words by graphically showing the plurality of phonemically similar words on the display screen. When the phonemically similar words are displayed, the present invention selects a teaching word from the plurality of phonemically similar words according to the presentation schedule. Next, the phonemic sections of the teaching word is audiovisually pronounced. This allows the user to identify the differences between each of the similar sounding words. While the phonemic sections are pronounced, the present invention also highlights each of the plurality of phonemic sections of the teaching word on the display screen as each of the plurality of phonemic sections of the teaching word is pronounced. Therefore, the user can effectively identify the different pronunciations related to each of the phonemic sections. The pronunciation and highlighting is executed for each of plurality of phonemically similar words as the teaching word. For further clarification, articulation is also included into the desired plan by audiovisually outputting a human mouth speaking each of the plurality of phonemic sections as each of the plurality of phonemic section is pronounced.

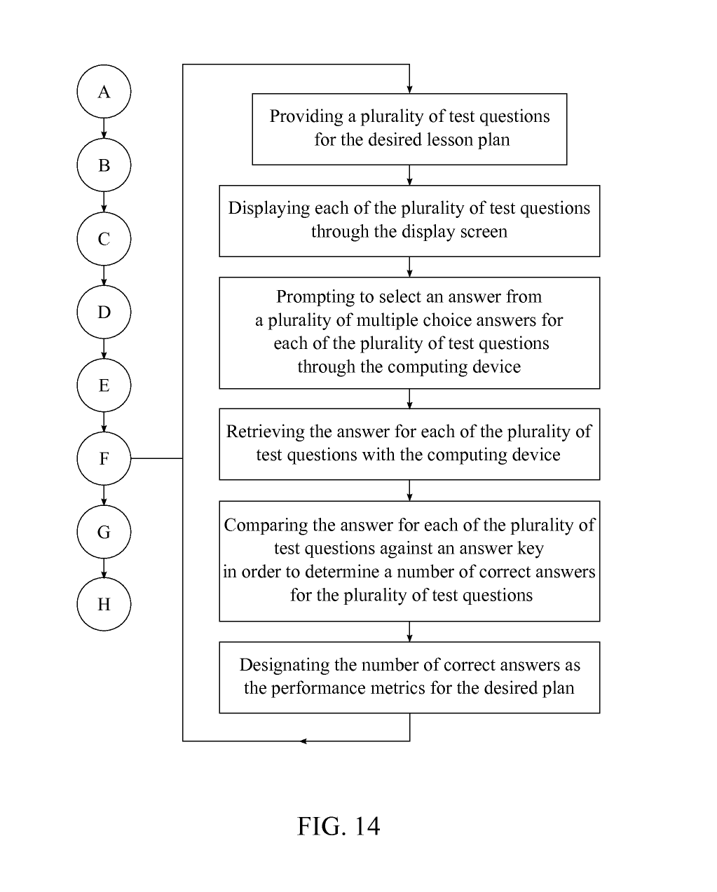

As discussed earlier, the present invention executes a testing process to evaluate the progress of the user. In order to do so, the present invention provides a plurality of test questions for the desired lesson plan as shown in FIG. 14. Each of the plurality of test questions are displayed through the display screen. When the plurality of test questions are displayed, the user is prompted to select an answer from a plurality of multiple choice answers for each of the plurality of test questions through the computing device. When the user submits the answer, the present invention retrieves the answer for each of the plurality of test questions with the computing device. Next, the present invention compares the answer for each of the plurality of test questions against an answer key in order to determine a number of correct answers for the plurality of test questions. Based on the number of correct answers, the present invention designates the number of correct answers as the performance metrics for the desired plan. As an example, if the user is tested on homonyms, a sample word is audibly played through the speaker. Next, the user is prompted to select the correct answer from a plurality of similar sounding words. The accuracy of the answer is determined based on the selection of the user and the answer key.

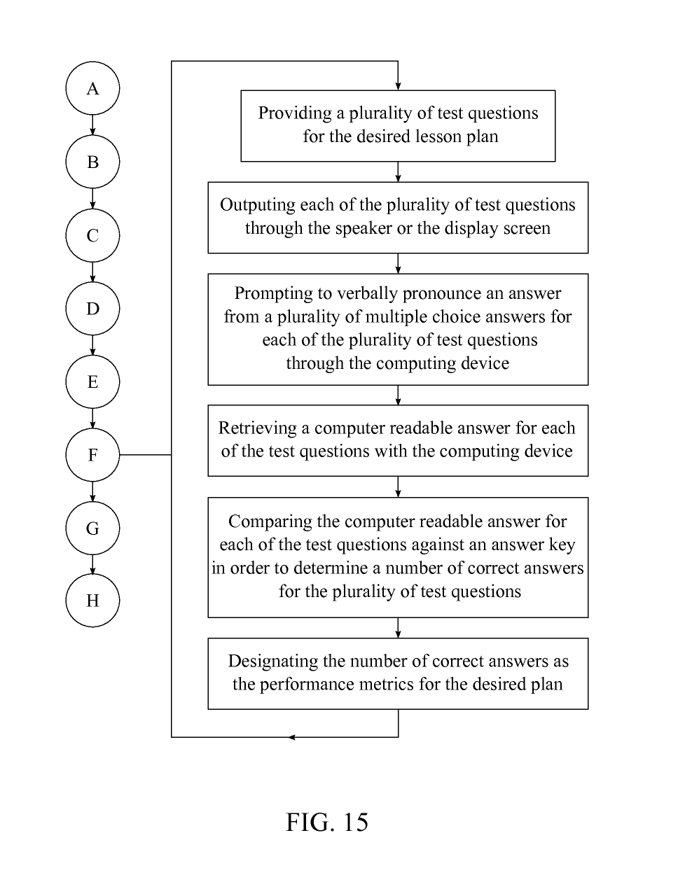

The knowledge the user has on pronouns, verbs, and tense in grammar, is tested through a different testing process. Similar to the previous testing method, the present invention provides a plurality of test question for the desired lesson plan. As illustrated in FIG. 15, each of the plurality of test questions are outputted through the speaker or the display screen in this testing method. Next, the user is prompted to verbally pronounce an answer for each of the plurality of test questions through the computing device. When the user verbally pronounces the answer, the present invention retrieves a computer readable answer for each of the plurality of test questions with the computing device. The computer readable answer is compared for each of the plurality of test questions against an answer key in order to determine a number of correct answers for the plurality of test questions. Finally, the number of correct answer are designated as the performance metrics for the desired plan.

Although the invention has been explained in relation to its preferred embodiment, it is to be understood that many other possible modifications and variations can be made without departing from the spirit and scope of the invention as hereinafter claimed.

What is claimed is:

1. A teaching method for addressing learning-based language disabilities on an electronic communication device by executing computer-executable instructions stored on a non-transitory computer-readable medium, the method comprises the steps of:
(A) providing a computing device, wherein the computing device includes a display screen, a speaker, and a user input device;
(B) providing a plurality of lesson plans, wherein each of the plurality of lesson plans includes audio teaching data, visual teaching data, and a presentation schedule;
(C) prompting to select a desired plan from the plurality of lesson plans through the computing device;
(D) outputting the audio teaching data for the desired plan at a specific time during the presentation schedule of the desired plan, wherein the audio teaching data for the desired plan is audibly outputted through the speaker;
(E) outputting the visual teaching data for the desired plan at a specific time during the presentation schedule of the desired plan, wherein the visual teaching data for the desired plan is visually outputted through the display screen;
(F) executing a testing process for a user profile in order to gather performance metrics for the desired plan through the user input device;
(G) repeating steps (C) through (F) as a plurality of iterations; and
(H) compiling the performance metrics for each of the plurality of iterations into a progress report for the user profile.

2. The teaching method for addressing learning-based language disabilities on an electronic communication device by executing computer-executable instructions stored on a non-transitory computer-readable medium, the method as claimed in claim 1 comprises the steps of:
(I) providing a spoken phrase as the audio teaching data of the desired plan, wherein the spoken phrase includes a pronoun and a gerund;
(J) providing a moving visual representation as the visual teaching data of the desired plan, wherein the moving visual representation is an enactment of the pronoun and the gerund;
(K) sequentially executing steps (L) and (M) with the computing device according to the presentation schedule of the desired plan;
(L) outputting the spoken phrase through the speaker; and
(M) outputting the moving visual representation through the display screen and simultaneously outputting the spoken phrase through the speaker.

3. The teaching method for addressing learning-based language disabilities on an electronic communication device by executing computer-executable instructions stored on a non-transitory computer-readable medium, the method as claimed in claim 2 comprises the steps of:
providing additional visual teaching data for the desired plan, wherein the additional visual teaching information is a moving visual representation of a human mouth speaking the pronoun and the gerund; and
outputting the moving visual representation of the human mouth speaking the pronoun and the gerund through the display screen and simultaneously outputting the spoken phrase through the speaker, after the computing device executes step (M).

4. The teaching method for addressing learning-based language disabilities on an electronic communication device by executing computer-executable instructions stored on a non-transitory computer-readable medium, the method as claimed in claim 1 comprises the steps of:
(N) providing a spoken phrase in past tense for a pronoun and a verb, a spoken phrase in gerund form for the pronoun and the verb, and a spoken phrase in future tense for the pronoun and the verb as the audio teaching data of the desired plan;
(O) providing a moving visual representation as the visual teaching data of the desired plan, wherein the moving visual representation is an enactment of the pronoun and the verb;
(P) sequentially executing steps (Q), (R), and (S) with the computing device according to the presentation schedule of the desired plan;
(Q) outputting the spoken phrase in future tense through the speaker;
(R) outputting the moving visual representation through the display screen and simultaneously outputting the spoken phrase in gerund form through the speaker; and
(S) outputting the spoken phrase in past tense through the speaker.

5. The teaching method for addressing learning-based language disabilities on an electronic communication device by executing computer-executable instructions stored on a non-transitory computer-readable medium, the method as claimed in claim 4 comprises the steps of:
providing additional visual teaching data of the desired plan, wherein the additional visual teaching information is a moving visual representation of a human mouth speaking the spoken phrase in future tense; and
outputting the moving visual representation of the human mouth speaking the spoken phrase in future tense through the display screen and simultaneously outputting the spoken phrase in future tense through the speaker, after the computing device executes step (Q).

6. The teaching method for addressing learning-based language disabilities on an electronic communication device by executing computer-executable instructions stored on a non-transitory computer-readable medium, the method as claimed in claim 4 comprises the steps of:
providing additional visual teaching data of the desired plan, wherein the additional visual teaching information is a moving visual representation of a human mouth speaking the spoken phrase in gerund form; and
outputting the moving visual representation of the human mouth speaking the spoken phrase in gerund form through the display screen and simultaneously outputting the spoken phrase in gerund form through the speaker, after the computing device executes step (R).

7. The teaching method for addressing learning-based language disabilities on an electronic communication device by executing computer-executable instructions stored on a non-transitory computer-readable medium, the method as claimed in claim 4 comprises the steps of:
providing additional visual teaching data of the desired plan, wherein the additional visual teaching information is a moving visual representation of a human mouth speaking the spoken phrase in past tense; and
outputting the moving visual representation of the human mouth speaking the spoken phrase in past tense through the display screen and simultaneously outputting the spoken phrase in past tense through the speaker, after the computing device executes step (S).

8. The teaching method for addressing learning-based language disabilities on an electronic communication device by executing computer-executable instructions stored on a non-transitory computer-readable medium, the method as claimed in claim 1 comprises the steps of:
(T) providing audiovisual data for the desired plan, wherein the audiovisual data is a combination of the audio teaching data and the visual teaching data;
(U) providing a group of people, a plurality of pronouns, and a contextually constant verb as animatable features of the audiovisual data, wherein each of the plurality of pronouns differs from each other by point of view and/or grammatical quantity;
(V) selecting a teaching pronoun from the plurality of pronouns according to the presentation schedule;
(W) audiovisually outputting at least one reciter from the group of people verbally reciting the teaching pronoun and the contextually constant verb, wherein the at least one reciter is based on the point of view and the grammatical quantity of the teaching pronoun;
(X) audiovisually outputting at least one actor from the group of people physically enacting the teaching pronoun and the contextually constant verb, wherein the at least one actor is based on the point of view and the grammatical quantity of the teaching pronoun; and
(Y) executing steps (V) through (X) for each of the plurality of pronouns as the teaching pronoun.

9. The teaching method for addressing learning-based language disabilities on an electronic communication device by executing computer-executable instructions stored on a non-transitory computer-readable medium, the method as claimed in claim 8, wherein at least one person from the group of people is a male.

10. The teaching method for addressing learning-based language disabilities on an electronic communication device by executing computer-executable instructions stored on a non-transitory computer-readable medium, the method as claimed in claim 8, wherein at least one person from the group of people is a female.

11. The teaching method for addressing learning-based language disabilities on an electronic communication device by executing computer-executable instructions stored on a non-transitory computer-readable medium, the method as claimed in claim 8, wherein steps (W) and (X) are executed with a combination of the speaker and the display screen.

12. The teaching method for addressing learning-based language disabilities on an electronic communication device by executing computer-executable instructions stored on a non-transitory computer-readable medium, the method as claimed in claim 1 comprises the steps of:
(Z) providing audiovisual data for the desired plan, wherein the audiovisual data is a combination of the audio teaching data and the visual teaching data;
(AA) providing a plurality of socially inappropriate requests, a socially appropriate request, a first actor, and a second actor as animatable features of the audiovisual data;
(BB) selecting a teaching request from the plurality of socially inappropriate requests according to the presentation schedule;
(CC) audiovisually outputting the first actor making the teaching request to the second actor;
(DD) audiovisually outputting the second actor responding to the first actor with a negative gesture;
(EE) executing steps (BB) through (DD) for each of the plurality of socially inappropriate requests as the teaching request;
(FF) audiovisually outputting the first actor making the socially appropriate request to the second actor; and
(GG) audiovisually outputting the second actor responding to the first actor with a positive gesture.

13. The teaching method for addressing learning-based language disabilities on an electronic communication device by executing computer-executable instructions stored on a non-transitory computer-readable medium, the method as claimed in claim 12, wherein steps (CC), (DD), (FF), and (GG) are executed with a combination of the speaker and the display screen.

14. The teaching method for addressing learning-based language disabilities on an electronic communication device by executing computer-executable instructions stored on a non-transitory computer-readable medium, the method as claimed in claim 12 comprises the steps of:
(HH) audiovisually outputting the first actor repeating the socially appropriate request; and
(II) audiovisually outputting a human mouth repeating the socially appropriate request.

15. The teaching method for addressing learning-based language disabilities on an electronic communication device by executing computer-executable instructions stored on a non-transitory computer-readable medium, the method as claimed in claim 1 comprises the steps of:
(JJ) providing audiovisual data for the desired plan, wherein the audiovisual data is a combination of the audio teaching data and the visual teaching data;
(KK) providing a teaching word and a person as animatable features of the audiovisual data;
(LL) audiovisually outputting the person reciting the teaching word;
(MM) audiovisually outputting the person verbally prompting to remove a specific phonemic section of the teaching word;
(NN) audiovisually outputting the person standing idle for a period of time defined by the presentation schedule; and
(OO) audiovisually outputting a remainder of the teaching word without the phonemic section.

16. The teaching method for addressing learning-based language disabilities on an electronic communication device by executing computer-executable instructions stored on a non-transitory computer-readable medium, the method as claimed in claim 15, wherein steps (LL), (MM), (NN), and (OO) are executed with a combination of the speaker and the display screen.

17. The teaching method for addressing learning-based language disabilities on an electronic communication device by executing computer-executable instructions stored on a non-transitory computer-readable medium, the method as claimed in claim 1 comprises the steps of:
(PP) providing audiovisual data for the desired plan, wherein the audiovisual data is a combination of the audio teaching data and the visual teaching data;
(QQ) providing a plurality of phonetically similar words as an animatable feature of the audiovisual data, wherein each of the plurality of phonemically similar words includes a plurality of phonemic sections;
(RR) audiovisually outputting the plurality of phonemically similar words by graphically showing the plurality of phonemically similar words on the display screen;
(SS) selecting a teaching word from the plurality of phonemically similar words according the presentation schedule;
(TT) audiovisually pronouncing the plurality of phonemic sections of the teaching word;
(UU) audiovisually highlighting each of the plurality of phonemic sections of the teaching word on the display screen as each of the plurality of phonemic sections of the teaching word is pronounced during step (SS); and
(VV) executing steps (SS) through (UU) for each of the plurality of phonemically similar words as the teaching word.

18. The teaching method for addressing learning-based language disabilities on an electronic communication device by executing computer-executable instructions stored on a non-transitory computer-readable medium, the method as claimed in claim 17 comprises the step of:
audiovisually outputting a human mouth speaking each of the plurality of phonemic sections as each of the plurality of phonemic sections is pronounced during step (SS).

19. The teaching method for addressing learning-based language disabilities on an electronic communication device by executing computer-executable instructions stored on a non-transitory computer-readable medium, the method as claimed in claim 1 comprises the step of:
providing a plurality of test questions for the desired lesson plan;
displaying each of the plurality of test questions through the display screen;
prompting to select an answer from a plurality of multiple choice answers for each of the plurality of test questions through the computing device;
retrieving the answer for each of the plurality of test questions with the computing device;
comparing the answer for each of the plurality of test questions against an answer key in order to determine a number of correct answers for the plurality of test questions; and
designating the number of correct answers as the performance metrics for the desired plan.

20. The teaching method for addressing learning-based language disabilities on an electronic communication device by executing computer-executable instructions stored on a non-transitory computer-readable medium, the method as claimed in claim 1 comprises the step of:
providing a plurality of test questions for the desired lesson plan;
sounding each of the plurality of test questions through the speaker;
prompting to verbally pronounce an answer for each of the plurality of test questions through the computing device;
retrieving a computer readable answer for each of the plurality of test questions with the computing device;
comparing the answer for each of the plurality of test questions against an answer key in order to determine a number of correct answers for the plurality of test questions; and
designating the number of correct answers as the performance metrics for the desired plan.
